(19) United States
(12) Patent Application Publication
(10) Pub. No.: US 2026/0326242 A1
(43) Pub. Date: Oct. 22, 2026

(54) LASER DEVICE AND METHOD FOR MACHINING AT LEAST ONE WORKPIECE BY MEANS OF AT LEAST TWO LASER BEAMS

(71) Applicant: TRUMPF Laser- und Systemtechnik SE, Ditzingen (DE)

(72) Inventors: Patrick Haug, Unteriflingen (DE); Oliver Bocksrocker, Sachsenheim (DE); Tim Hesse, Ditzingen (DE); Nicolai Speker, Pleidelsheim (DE)

(21) Appl. No.: 19/691,635

(22) Filed: May 29, 2026

Related U.S. Application Data
(63) Continuation of application No. PCT/EP2024/083712, filed on Nov. 27, 2024.

(30) Foreign Application Priority Data
Dec. 6, 2023 (DE) 10 2023 134 098.0

(51) Int. Cl. B23K 26/36; B23K 26/082; B23K 26/14

(52) U.S. Cl. CPC B23K 26/36; B23K 26/082; B23K 26/1462

(57) ABSTRACT

A laser device for machining a workpiece by using at least two laser beams is provided. The laser device is configured to generate the at least two laser beams. Each of the at least two laser beams has an initial power. The laser device is further configured to focus the at least two laser beams on the workpiece, and vary the initial power of the at least two laser beams with a variation frequency of at least 50 kHz and a variation amplitude of at least 10% of the initial power.

### CROSS REFERENCE TO RELATED APPLICATIONS

This application is a continuation of International Application No. PCT/EP2024/083712 (WO 2025/119720A1), filed on Nov. 27, 2024, and claims benefit to German Patent Application No. DE 10 2023 134 098.0, filed on Dec. 6, 2023. The aforementioned applications are hereby incorporated by reference herein.

### FIELD

Embodiments of the present invention relate to a laser device for machining at least one workpiece and a method for machining at least one workpiece.

### BACKGROUND

In the case of the laser welding of at least two components, CW lasers (continuous wave) with a constant power over the duration of the laser welding process are typically used for deep welding. Particularly in the case of the deep welding of metallic materials with a low viscosity, instabilities can occur in the welding region, in particular in the so-called keyhole. This can result in, for example, spatter, pores and/or an uneven welding penetration depth. To reduce such instabilities, a plurality of laser beams can be superposed. However, this does not eliminate all instabilities, in particular in metallic materials which have low viscosity.

### SUMMARY

Embodiments of the present invention provide a laser device for machining a workpiece by using at least two laser beams. The laser device is configured to generate the at least two laser beams. Each of the at least two laser beams has an initial power. The laser device is further configured to focus the at least two laser beams on the workpiece, and vary the initial power of the at least two laser beams with a variation frequency of at least 50 kHz and a variation amplitude of at least 10% of the initial power.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a laser device for machining at least one workpiece according to some embodiments; and

FIG. 2 shows a schematic diagram of the power curve of a CW laser of the laser device according to FIG. 1, according to some embodiments.

### DETAILED DESCRIPTION

Embodiments of the present invention provide a laser device and a method for machining, in particular laser-welding, at least one workpiece, in which the above disadvantages are eliminated.

The laser device is configured to generate at least two, in particular at least four, laser beams, each having an initial power, to focus them onto the workpiece, and to vary the initial power of the laser beams with a variation frequency of at least 50 kHz (kilohertz) and a variation amplitude of at least 10% of the initial power. The variation amplitude can be either positive or negative. In other words, the initial power can be periodically increased (with a positive variation amplitude) and/or reduced (with a negative variation amplitude).

This can achieve (additional) stabilization of the keyhole, in particular in workpieces with a lower viscosity, thereby reducing spatter and pores and achieving the most continuous possible welding penetration depth. Keyhole instabilities can be avoided or at least reduced in particular by increasing and decreasing the vapor rate and vapor pressure quickly enough to prevent the keyhole from collapsing. In other words, the keyhole can be stabilized by selectively influencing the vapor pressure (or vapor rate), which can lead to fewer spatters, fewer pores and a constant welding penetration depth. In particular, stabilization of the wall of the keyhole can be achieved.

The laser device can have a beam shaping element for generating a “multifocus beam”. The beam shaping element can comprise one or more optical wedges.

According to a further development of the laser device, all laser beams can each be identical in design.

This simplifies the generation of laser beams and allows it to be implemented using simple means.

According to a further development of the laser device, at least one laser beam, in particular at least two laser beams, can each have a higher power than the remaining laser beams. For example, it is conceivable that, in the case of two laser beams, a first laser beam can be arranged in an advancement direction in front of a second laser beam, and the power of the first laser beam can be higher than the power of the second laser beam. Accordingly, for example, in the case of four laser beams, two first laser beams can be arranged in the advancement direction in front of two second laser beams, and the two first laser beams can have a higher power than the two second laser beams. In the case of four laser beams, the laser beams can be focused or arranged in a quadrangular, in particular rectangular, preferably square, pattern on the workpiece.

This allows the welding region, in particular the keyhole, to be further stabilized. This can lead to a further reduction in instability (within the keyhole) and to fewer spatters and pores, as well as a constant welding penetration depth.

According to a further development of the laser device, the laser device for generating the laser beams can comprise a CW laser. The laser device can be configured in such a way that the laser beams are each modulated with a modulation frequency and a modulation amplitude. The modulation frequency can correspond to the variation frequency, and the modulation amplitude can correspond to the variation amplitude. The CW laser can have an average power of at least 0.2 kW (kilowatts), preferably at least 4 kW.

This allows the laser beams to be generated using simple means.

It is also conceivable that the laser device for generating the laser beams can comprise a pulsed laser. The pulse repetition rate of the pulsed laser can correspond to the variation frequency. The pulsed laser can have an average power of at least 0.2 kW, preferably at least 4 kW, and/or a pulse energy of at least 10 mJ (millijoules), preferably at least 50 mJ.

It is conceivable that the core region of the laser spot is generated by means of a pulsed laser (in particular an ns (nanosecond) pulsed laser) and the ring region of the laser spot is generated by means of a CW laser or vice versa.

The pulsed laser and/or the CW laser can each have a beam parameter product of at most 8 mm*mrad (millimeters*milliradians). The pulsed laser and/or the CW laser can each be designed as a (multi-mode) NIR laser (near infrared). It is also conceivable that the pulsed laser and/or the CW laser could each be designed as a laser in the visible range (VIS laser) with a wavelength in a blue or green wavelength range. The pulsed laser and/or the CW laser can each be designed as a solid-state laser.

The laser device can comprise a control device. The control device can be configured for programming and/or controlling the (high frequency) modulation or pulsation with a variation frequency of at least 50 kHz.

According to a further development of the laser device, the laser device can be configured in such a way that the laser beams each generate a laser spot on the workpiece. The laser spot can have a core region and a ring region. The core region can be circular. The ring region can be annular. The core region can be arranged within the ring region. The average laser power density in the core region can be higher than the average laser power density in the ring region. The average laser power density in the ring region can be in particular at most 5% of the laser power. To generate the core or ring regions, the laser device can comprise an optical element for beam splitting, in particular a wedge switch.

This allows the welding region, in particular the keyhole, to be further stabilized. This can lead to a further reduction in instability (within the keyhole) and to fewer spatters and pores, as well as a constant welding penetration depth.

According to a further development of the laser device, the laser device for generating the laser beams and/or the laser spots can comprise a fiber (2 in 1 fiber) with a core region and a ring region. The core region of the fiber can have an outer diameter of at most 30 μm (micrometers), in particular at most 20 μm, preferably at most 10 μm (e.g., in the case of fundamental mode or single mode). Alternatively, the core region of the fiber can have a larger outer diameter, in particular at least 50 μm or 100 μm (e.g., in the case of multi-mode). The ring region can have an outer diameter of 200 μm or 400 μm. The core region can be arranged within the ring region. The ratio between the outer diameter of the core region and the outer diameter of the ring region can be in the range of 1:2 to 1:9, in particular 1:3, 1:4 or 1:6. The core region can have a cladding. The cladding can be arranged between the core region and the ring region. The cladding can have a thickness of at most 10 μm.

This allows the welding region, in particular the keyhole, to be further stabilized. This can lead to a further reduction in instability (within the keyhole) and to fewer spatters and pores, as well as a constant welding penetration depth.

According to a further development of the laser device, the laser device can be configured in such a way that the rise time and/or fall time of the variation amplitude is at most 10 μm.

In this context, rise time refers to the time required to increase the laser power to a maximum value (e.g., the positive variation amplitude). Accordingly, a fall time refers to the time required to reduce the laser power to a minimum value (e.g., the negative variation amplitude).

This allows the welding region, in particular the keyhole, to be further stabilized. This can lead to a further reduction in instability (within the keyhole) and to fewer spatters and pores, as well as a constant welding penetration depth.

According to a further development of the laser device, the laser device can comprise a swivel optical unit for moving the laser beams over the workpiece. The swivel optical unit can be designed as a swivel optical unit. The swivel optical unit can have a magnification in a range of 1:1 to 5:1.

This makes it possible to advance the laser beams on the workpiece using simple means.

According to a further development of the laser device, the laser device can comprise at least one nozzle for supplying a shielding gas (cutting or welding gas) to the workpiece. The nozzle can have a Laval internal geometry.

This allows for the supply of the shielding gas using simple means, thus further optimizing the machining of the workpiece.

Embodiments of the present invention also provide a method for machining a workpiece by means of at least two laser beams. The machining may be laser welding. The method comprises the steps:

Preparing the workpiece. The workpiece can be made of metal, in particular aluminum and/or copper. The workpiece can have a viscosity of at most 5 mPa*s (millipascals*second) in its molten state (at melting temperature). The workpiece can have a thickness of at most 4 mm (millimeters).

Generating and focusing at least two, in particular at least four, laser beams, each having an initial power, onto the workpiece.

Varying, in particular pulsing or modulating, the laser beams with a variation frequency of at least 50 kHz and a variation amplitude of at least 10% of the initial power. The rise time and/or fall time of the variation amplitude can be less than 10 μs (microseconds). The variation amplitude can be either positive or negative. In other words, the initial power can be periodically increased (with a positive variation amplitude) and/or reduced (with a negative variation amplitude).

This can achieve (additional) stabilization of the keyhole, in particular in workpieces with a lower viscosity, thereby reducing spatter and pores and achieving the most continuous possible welding penetration depth. Keyhole instabilities can be avoided or at least reduced in particular by increasing and decreasing the vapor rate and vapor pressure quickly enough to prevent the keyhole from collapsing. In other words, the keyhole can be stabilized by selectively influencing the vapor pressure (or vapor rate), which can lead to fewer spatters, fewer pores and a constant welding penetration depth. In particular, stabilization of the wall of the keyhole can be achieved.

The method can comprise the step of:

Supplying a shielding gas (cutting or welding gas) to the workpiece, in particular in the region where the workpiece is being machined. This can be implemented by means of a nozzle, in particular one having a Laval internal geometry.

According to a further development of the method, the method can comprise the step:

Moving the laser beams and/or the workpiece to advance the laser beams focused on the workpiece in an advancement direction. The laser beams can be moved over the workpiece by means of a swivel optical unit. The movement of the laser beams and/or the workpiece can be a relative movement between the laser beams and the workpiece. In other words, either the laser beams or the workpiece, or both, can be moved. At least one first laser beam is arranged in the advancement direction in front of at least one second laser beam. The first laser beam has a higher power than the second laser beam. It is also conceivable that at least two first laser beams are arranged in the advancement direction in front of at least two second laser beams, and the first laser beams have a higher power than the second laser beams.

This allows for continuous machining of the workpiece, e.g., a weld seam, to be achieved using simple means, and the keyhole, in particular at least one wall of the keyhole, can be further stabilized.

According to a further development of the method, a laser device as described above can be used to carry out the method.

With regard to the advantages that can be achieved, reference is made to the relevant statements relating to the laser device. The measures described in connection with the laser device and/or those explained below can be used to further develop the method.

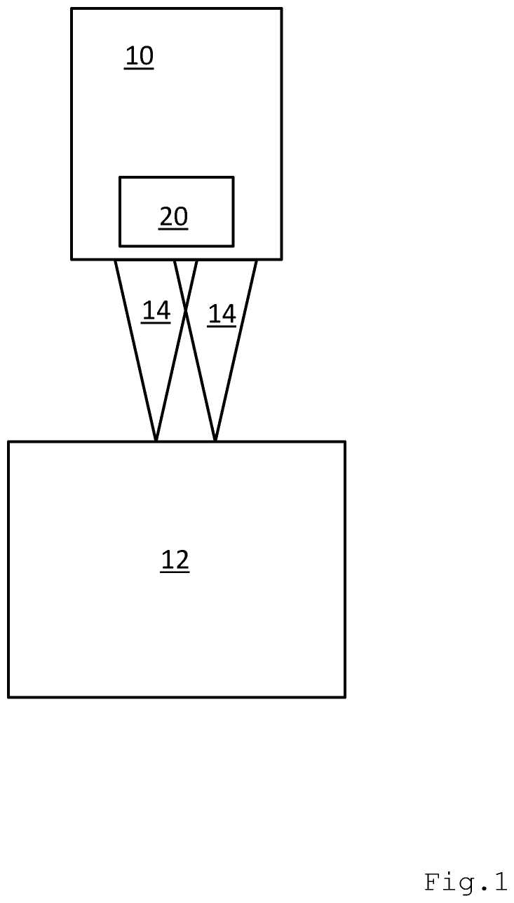

FIG. 1 schematically shows a laser device 10 for machining at least one workpiece 12 by means of at least two laser beams 14. In the present case, the machining is laser welding.

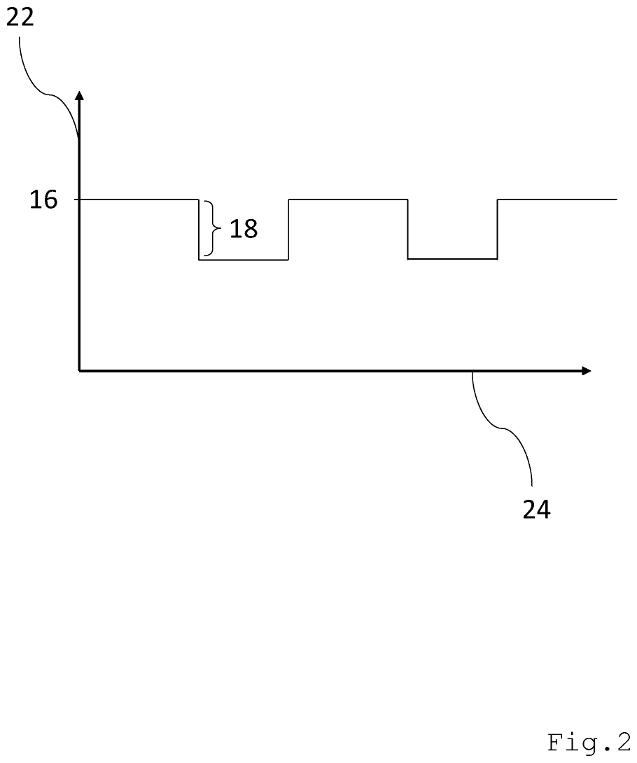

The laser device 10 is configured to generate at least two, in particular at least four, laser beams 14, each having an initial power 16 (see FIG. 2), and to focus them onto the workpiece 12. The laser device 10 is further configured to vary the initial power 16 of the laser beams 14 with a variation frequency of at least 50 kHz and a variation amplitude 18 of at least 10% of the initial power 16.

The laser device 10 can also be configured such that the rise time and/or fall time of the variation amplitude 18 is at most 10 μs.

In the present case, the laser beams 14 are each identical in design. It is also conceivable that at least one laser beam 14, in particular at least two laser beams 14, each have a higher power than the remaining laser beams 14.

The laser device 10 can comprise a CW laser for generating the laser beams 14. The laser device 10 can be configured such that the laser beams 14 are modulated with a modulation frequency and a modulation amplitude. The modulation frequency can correspond to the variation frequency and the modulation amplitude can correspond to the variation amplitude 18. The CW laser can have an average power of at least 1 kW, in particular at least 4 kW.

In the present case, the laser device 10 comprises a swivel optical unit 20 for moving the laser beams 14 over the workpiece 12. The swivel optical unit 20 can have a magnification in a range of 1:1 to 5:1. In the present case, the swivel optical unit 10 is designed as a welding optical unit.

The laser device 10 can comprise at least one nozzle for supplying a shielding gas to the workpiece 12; and this nozzle can have a Laval internal geometry.

The laser device 10 can be configured such that the laser beams 14 each generate a laser spot on the workpiece 12. The laser spot can have an, in particular circular, core region. The laser spot can have an, in particular annular, ring region. The core region of the laser spot can be arranged within the ring region of the laser spot. The average laser power density in the core region of the laser spot is higher than the average laser power density in the ring region of the laser spot.

The laser device 10 can comprise at least one fiber to generate the laser beams 14 and/or the laser spots. The fiber can comprise a core region and a ring region. The core region can be arranged within the ring region. The core region can have an outer diameter of 50 μm or 100 μm. The ring region can have an outer diameter of 200 μm or 400 μm.

FIG. 2 shows a schematic diagram of the power curve of the CW laser of the laser device 10 according to FIG. 1.

The diagram shown plots the power 22 of the CW laser of the laser device 10 in watts over a time 24 in seconds. In other words, the x-axis represents the time 24 in seconds and the y-axis represents the power 22 in watts.

The power 22 of the CW laser is modulated in the present case with the modulation frequency and the modulation amplitude. In other words, the initial power 16 of the CW laser is periodically varied by at least 10% (modulation amplitude). The initial power 16 of the CW laser is thus changed by the modulation amplitude or the variation amplitude 18 at regular intervals of at most 20 μs (since the modulation frequency or variation frequency is at least 50 kHz). In the example shown, the initial power 16 is reduced by the variation amplitude 18 at intervals of at most 20 μs and then increased again to the value of the initial power 16. In the present case, the variation amplitude is greater than 10% and less than 100% of the initial power 16.

The rise time is the time required to increase the power 22 of the CW laser from a minimum value to a maximum value (the value of the initial power 16 in the present case). Accordingly, the fall time is the time required to reduce the power 22 of the CW laser from the maximum value to the minimum value. The diagram shown here is merely schematic, so the rise time and fall time are shown as vertical edges (=zero seconds) and therefore not to scale. The rise time and the fall time can each be less than 10 μs.

The following describes a method for machining, in particular laser-welding, at least one workpiece 12 with reference to FIGS. 1 and 2. The method comprises the steps:

Providing the workpiece 12. The workpiece 12 can be made of metal, in particular aluminum and/or copper. The workpiece 12 can have a viscosity of at most 5 mPa*s in the molten state.

Generating and focusing at least two, in particular at least four, laser beams 14, each having an initial power 16, onto the workpiece 12.

Varying, in particular pulsing or modulating, the laser beams 14 with a variation frequency of at least 50 kHz and a variation amplitude 18 of at least 10% of the initial power 16. The rise time and/or fall time of the variation amplitude 18 can be less than 10 μs.

The method can comprise the step of:

Moving the laser beams 14 and/or the workpiece 12 to advance the laser beams 14 focused on the workpiece 12 in an advancement direction. At least one first laser beam 14 is arranged in the advancement direction in front of at least one second laser beam 14. The first laser beam 14 can have a higher power than the second laser beam 14. In the case of at least four laser beams 14, at least two first laser beams 14 can be arranged in the advancement direction in front of at least two second laser beams 14. The first laser beams 14 can each have a higher power than the second laser beams 14.

To carry out the method, a laser device 10 according to the above descriptions, in particular the laser device 10 shown in FIG. 1, can be used.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser device for machining a workpiece by using at least two laser beams, the laser device being configured to:
generate the at least two laser beams, each of the at least two laser beams having an initial power,
focus the at least two laser beams on the workpiece, and
vary the initial power of the at least two laser beams with a variation frequency of at least 50 kHz and a variation amplitude of at least 10% of the initial power.

2. The laser device according to claim 1, wherein the at least two laser beams are identical in configuration.

3. The laser device according to claim 1, wherein at least one laser beam of the at least two laser beams has a higher power than remaining laser beams of the at least two laser beams.

4. The laser device according to claim 1, comprising at least one continuous-wave (CW) laser, the laser device being configured such that each of the at least two laser beams is modulated with a modulation frequency and a modulation amplitude, the modulation frequency corresponding to the variation frequency, and the modulation amplitude corresponding to the variation amplitude, wherein the CW laser has an average power of at least 0.2 kW.

5. The laser device according to claim 1 being configured such that each of the at least two laser beams generates a laser spot on the workpiece, wherein the laser spot has a core region and a ring region, wherein an average laser power density in the core region is higher than an average laser power density in the ring region.

6. The laser device according to claim 5, comprising at least one fiber having a fiber core region and a fiber ring region.

7. The laser device according to claim 1 being configured such that a rise time and/or a fall time of the variation amplitude is at most 10 μs.

8. The laser device according to claim 1, comprising a swivel optical unit for moving the at least two laser beams over the workpiece.

9. The laser device according to claim 1, comprising at least one nozzle for supplying a shielding gas to the workpiece.

10. A method for machining a workpiece by using at least two laser beams, the method comprising:
providing the workpiece;
generating and focusing the at least two laser beams onto the workpiece, each of the at least two laser beams having an initial power; and
varying the at least two laser beams with a variation frequency of at least 50 kHz and a variation amplitude of at least 10% of the initial power.

11. The method according to claim 10, further comprising:
moving the at least two laser beams and/or the workpiece to advance the at least two laser beams focused on the workpiece in an advancement direction, wherein a first laser beam of the at least two laser beams is arranged in the advancement direction in front of at least a second laser beam of the at least two laser beams, the first laser beam having a higher power than the second laser beam.
